(19) United States
(12) Patent Application Publication
(10) Pub. No.: US 2006/0192426 A1
(43) Pub. Date: Aug. 31, 2006

(54) Method for bleeding and refilling an electrohydraulic brake system

(76) Inventors: Martin Baechle, Glashutten (DE); Axel Wagner, Schluchtern (DE); Michael Hitzel, Rodermark (DE)

Correspondence Address: Robert P Seitter;RatnerPrestia, One Westlakes Berwyn Suite 301, PO Box 980, Valley Forge, PA, 19482-0980, US

(21) Appl. No.: 10/524,389

(22) PCT Filed: Aug. 12, 2003
(86) PCT No.: PCT/EP03/08934

§ 371 Date: Oct. 26, 2005

(30) Foreign Application Priority Data
Aug. 14, 2002 (DE) 102 37 183.0
Mar. 5, 2003 (DE) 103 09 479.2

(51) Int. Cl. B60T 8/36

(52) U.S. Cl. 303/119.1

(57) ABSTRACT

The problem underlying the invention resides in that in particular in electrohydraulic brake systems certain areas in the conduit system are not reached during conventional bleeding. This especially occurs if, during repair work carried out on the system, the intake conduit of the pump of the system is detached. Accordingly, in the practice of the invention, a pump-operated bleeding is provided wherein, among other things, pressure fluid from the pressure fluid reservoir, with the outlet valves opened, is returned, by means of the outlet valves, by the pump to the reservoir. To that effect, the pump and the outlet valves, respectively, can be actuated in clockwise manner, thereby producing pressure pulses capable to remove adhering air bubbles.

### TECHNICAL FIELD

The present invention generally relates to a method for bleeding and refilling and more particularly relates to a method for bleeding and refilling an electrohydraulic brake system, comprising a pedal-operated master brake cylinder and a brake circuit controlled by the master brake cylinder pressure, including a pump.

### BACKGROUND OF THE INVENTION

In a hydraulic brake system of the afore-described type wherein parts of the conduit system are closed by valves, a conventional bleeding operation will not be adequate to maintain all areas of the brake system free of air and gas bubbles, as a conventional bleeding will only reach the brake conduit between the master brake cylinder and the given wheel brake. Especially in cases, where the intake conduit of the pump leading to the pressure fluid reservoir must be detached for repair purposes, the ingress of air into the pump is likely to occur, which will not automatically rise to be passed into the pressure fluid reservoir, nor can it be removed by conventional bleeding. As the said air is likely to get into the brake circuit it is necessary to remove it prior to starting the car.

Citation DE 38 06 840 C2 discloses a bleeding system for use with an ABS brake system provided with a pump operated for bleeding the return conduit. As the said ABS system is a closed system wherein the pump directly supplies pressure fluid from the wheel brakes to the master brake cylinder (return feed) for decreasing the wheel brake pressure, the problem of an ingress of air into the intake conduit is not encountered.

### BRIEF SUMMARY OF THE INVENTION

Hence, the underlying problem of the invention in respect of a pressure fluid reservoir for an electrohydraulic brake system furnished with an open returning system, with the pumps delivering from a non-pressurized pressure fluid reservoir, resides in providing a method enabling all areas of the brake system, in particular, the intake area of the pump, to be bled.

To solve the afore-described problem, it is provided, in the practice of the invention, to carry out the following process steps:
1. Connecting a bleeding bottle to the wheel bleeder connections on the wheel brakes.
2. Connecting a bleeding device to a filling nozzle of the pressure fluid reservoir.
3. Activating the pump and delivering pressure fluid from the reservoir.
4. Connecting the inlet and outlet valves and the cut-off valves such that the pressure fluid is fed from the high-pressure accumulator either to the wheel bleeding nozzles or into the pressure fluid reservoir

Bleeding of the intake area, in particular, is effected by the latter alternative of process step 4.

The former mentioned alternative of process step 4 serves for bleeding additional areas of the brake system.

As major parts of the conduit system correspond to a conventional brake system (i.e. the brake conduits leading from the master brake cylinder by means of cut-off valves, to the wheel brakes) bleeding thereof can be in a conventional way, i.e. pressure fluid is pumped by a bleeding device provided on the pressure fluid reservoir from the master brake cylinder, by means of the brake conduits, to the wheel brakes where it is discharged on corresponding wheel bleeding connections. This type of conventional bleeding can be made in beforehand of process step 3.

To bleed the other areas of the brake system, a pump will be activated and the valves of the system so actuated as to cause the pump to deliver fresh pressure fluid to those areas, it being also possible for the pump to be actuated in a clockwise manner to generate pressure pulses eliminating air bubbles, if any, in the conduit system. The same effect is attained if the outlet valves are actuated in clockwise manner.

To insure a bleeding of all areas, the following steps are taken:
1. first, conventional bleeding in the direction of the wheel bleeder connections;
2. bleeding by a pump also in the direction of the wheel bleeder connection;
3. subsequent filling of the accumulator and bleeding in the direction of the wheel bleeder connections;
4. refilling of the accumulator and bleeding in the direction of the pressure fluid reservoir;
5. finally, again bleeding by the pump in the direction of the wheel bleeder connections.

By the latter bleeding step, also a check as to the proper connection of the brake conduits can be performed. To that effect, bleeding is respectively for one wheel brake, i.e. with the wheel bleeder connection opened, while those of the other wheel brakes are closed. By opening the respective inlet valves, a corresponding pressure builds up in the wheel brakes. The gradual formation of all four wheel brakes into triplets will disclose whether any conduits have been crossed, because a pressure build-up in each of the partial steps is allowed to develop only in those wheel brakes the inlet valves of which are opened. Should deviations to that effect occur, the inlet valves would no longer be correctly associated to the wheel brakes.

### BRIEF DESCRIPTION OF THE DRAWINGS

FIG. 1 shows the hydraulic circuit diagram of a hydraulic brake system,

FIG. 2 shows a diagram for illustrating a first sequence of the process of the invention,

FIG. 3 shows a diagram for illustrating a second sequence of the process of invention,

FIG. 4 shows a diagram for illustrating a third sequence of the process of the invention,

FIG. 5 shows a diagram for illustrating a fourth sequence of the process of the invention,

FIG. 6 shows a diagram for illustrating a fifth sequence of the process of the invention.

### DETAILED DESCRIPTION OF THE PREFERRED EMBODIMENTS

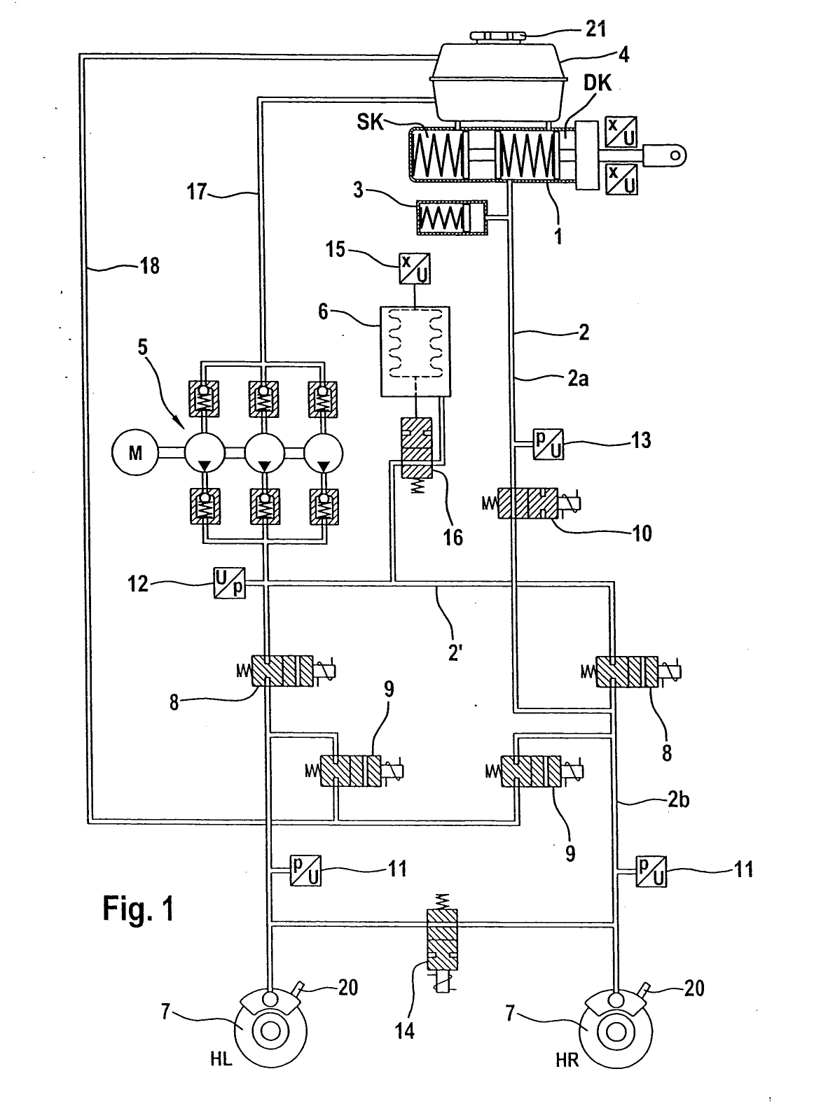

First, reference is made to FIG. 1 showing a typical electrohydraulic brake system of the following design:

A master brake cylinder 1 of tandem configuration comprises two brake circuits, i. e. a primary circuit (also designated by push-rod circuit DK), and a secondary circuit SK, with the illustrated primary brake circuit 2 being in communication with a pedal-operated simulator 3. Moreover, a pressure fluid reservoir 4 is connected to the master brake cylinder 1. Motor-driven pumps 5 and a high-pressure accumulator, e.g. a metal boot accumulator 6, form a pressure supply system to which pressure fluid (brake fluid) is supplied from the pressure fluid reservoir 4. To that effect, pump 5, by means of an intake conduit 17, is in communication with the pressure fluid reservoir 4. The wheel brakes 7 of the rear axle, by means of an inlet valve each 8, are in communication with the said pressure fluid supply system. Moreover, a connection to the pressure fluid reservoir 4 can be established by means of one outlet valve 9 each and a return conduit 18. The inlet and outlet valves 8, 9, normally, are closed. A pressure build-up in the wheel brakes 7 is by opening the given inlet valve 8, whereas a pressure decrease is by opening the given outlet valve 9. In this way, a controlled brake circuit 2′ is formed, with the pressure delivered to the wheel brakes 7 being dependent on the master brake cylinder pressure which, in a controlled braking operation, is hydraulically separated from the wheel brakes 7. To that effect, a cut-off valve 10 is provided in conduit 2a opening downstream of the inlet valve 8 into conduits 2b leading to the wheel brakes 7, with the said cut-off valve, in the control mode, being closed, remaining open only in case of a failure of the controlled brake circuit 2′, i.e. in case of a failure of the pressure fluid supply.

The system, among others, is monitored and controlled by various pressure sensors. Associated with the individual wheel brakes 7 are brake pressure sensors 11; pump pressure sensor 12 is associated with the pressure fluid supply system, while a simulation pressure sensor 13 is associated with the master brake cylinder per brake circuit. In an electrohydraulic braking operation, the cut-off valve is closed. The pressure in the master brake cylinder serves as a control value. To that effect, the pressure of the master brake cylinder 1 is measured by the simulation pressure sensor 13 and is passed as a control value to the control system of the controlled brake circuit 2′. In case of a failure of the pressure supply system, the cut-off vale 10 remains opened. The wheel brakes 7, hence, are directly connected, in a conventional way, by means of conduits 2a and 2b, to the master brake cylinder 1. A compensating valve 14 will insure a pressure balance between the wheel brakes of an axle.

The brake system must be regularly serviced, in particular, the brake fluid must be exchanged. Errors are not unlikely to occur, with connections transposed or the brake system not properly bled resulting in air bubbles. Accordingly, the following process is suggested for controlling the brake system:

The wheel brakes 7 are, as only schematically shown, provided with wheel bleeder connections 20, possibly valve-controlled, by means of which pressure fluid can be discharged from the brake circuits.

For bleeding and refilling the system, bleeder bottles are connected to the said wheel bleeder connections 20 collecting the pressure fluid discharged from the brake circuits.

Moreover, a so-called bleeder device is connected to the filling nozzle 21 of the pressure fluid reservoir 4, providing fresh brake fluid and being able to build up a pressure of about 2 bar to accelerate the bleeding operation.

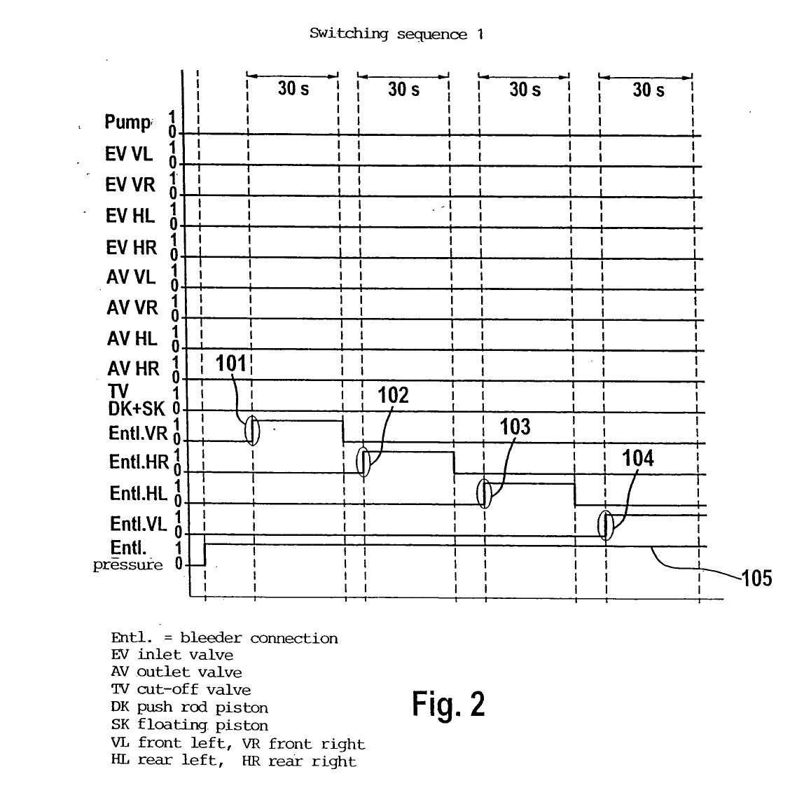

The individual sequences for carrying out the bleeding operation and for refilling the hydraulic brake system are shown in the form of diagrams illustrated in FIGS. 2-6. Plotted on the horizontal axis is the time and on the vertical axis the connection states of the individual components of the brake system. The curves in the diagram are indicative of the connection state of the individual component. From top to bottom, the following components are considered:

Pump: With the following connection states: 0: off; 1: pumping

Inlet valves EV: With the following connection states: 0: closed; 1: opened

Outlet valves AV: With the following connection states: 0: closed; 1: opened.

In the inlet and outlet valves EV and AV the abbreviations VL, VR, HL, HR mean: front to the left; front to the right; rear to the left; and rear to the right.

Cut-off valve TV: In respect of the push-rod circuit DK and the secondary circuit SK, with the following connection states: 0: opened; 1: closed

Wheel bleeder connections ENTL: With the following connection states: 0: closed; 1: opened

Bleeder device ENTL pressure: With the following connection states: 0: non-pressurized; 1: activated with pressure applied to the pressure fluid reservoir 4 (bleeder pressure).

If all valves and the pump are in the 0 state, the brake system will be in the basic state. During the entire bleeding procedure, the bleeder device is in connected condition so that bleeder pressure is applied to the brake system (state 1).

The first connection sequence as shown in FIG. 2 easily conveys that the wheel bleeder connections VR, HR,VL and VR are successively opened for about 30 seconds (markings 101, 102, 103, 104), with a bleeder pressure (marking 105) being permanently applied. Pressure fluid flows through the conventional brake circuit comprising master brake cylinder 1, cut-off valve 2, brake circuits 2a, 2b and wheel brakes 7, thereby bleeding the said brake circuit. The controlled brake circuit 2′ will not be affected thereby as both the inlet valves 8 and the outlet valves 9 remain closed. This operation corresponds to conventional bleeding, i.e. bleeding of a conventional non-controlled brake system.

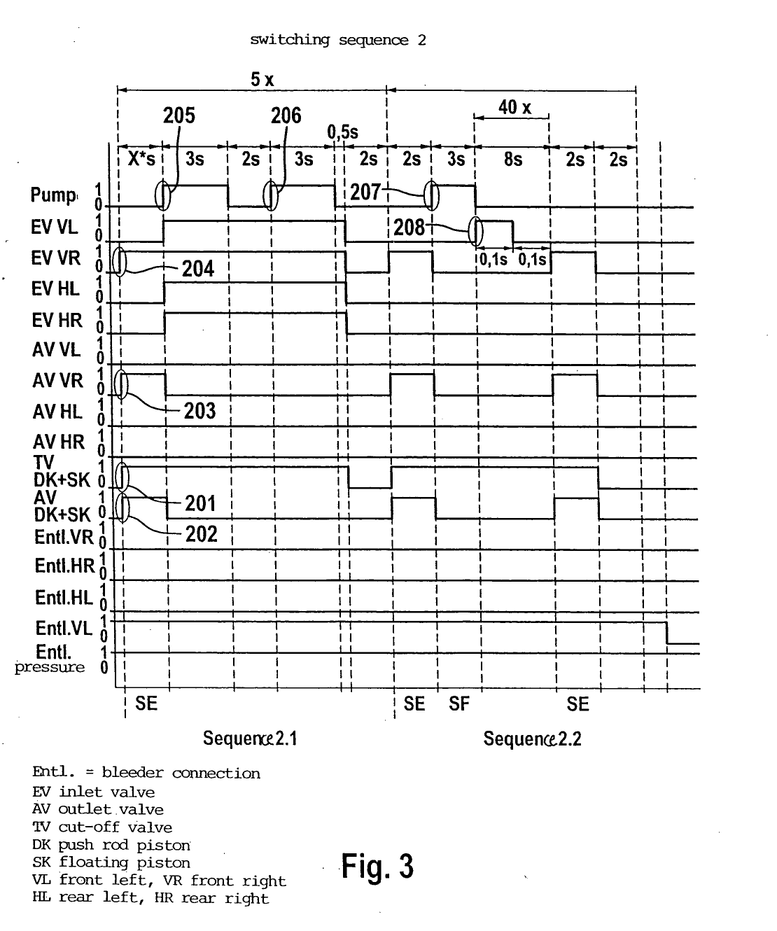

In the following diagrams of FIG. 3 the connection state of the compensating valve AV 14 is additionally shown in the push-rod circuit and in the secondary circuit. The states are 0: opened and 1: closed.

The second circuit sequence starts with an accumulator evacuation SE in which the cut-off valves 10 (marking 201) and the compensating valves 14 (marking 202) are closed. Moreover, the inlet valve 8 and the outlet valve 9 for a wheel brake, e.g. the one at the front to the right, is opened (marking 203, 204) resulting in an evacuation of the accumulator 6 by means of the return conduit 18.

Thereafter, all inlet valves 8, in a partial sequence 2.1, are opened, all outlet valves and the cut-off valves 10 of the two brake circuits are closed, with the compensating valves 14 remaining opened. Moreover, the wheel bleeder connection at the front to the left remains open and the wheel bleeder connection 20 on which is provided the bleeder bottle, respectively, remains open so that pumps 5 deliver from the pressure fluid reservoir 4 to the said wheel bleeder connection 20 (marking 205, 206). Especially the intake conduit 17 is flushed and thereby bled. If need be, circuit breaks are to be provided for pumps 5. For terminating the said partial sequence 2.1, the inlet valves 8 are closed again; in this respect, it should be noted that pumps 5 cease to operate a short time before, in order to prevent pressure peaks from occurring. The partial sequence 2.1 can be repeated up to 5 times.

The following partial sequence 2.2 initially provides again for an accumulator evacuation SE and a subsequent defined filling SF, wherein the inlet valves 8 are closed while pump 5 delivers (marking 207). Then the inlet valve at the front to the left, in short repeats of less than 0.1 seconds, is opened and closed 40 times (marking 208) so that the accumulator 6 is evacuated in clockwise manner, enabling the pressure fluid to flow off by means of bleeder connection 20 at the front to the left. Due to the pulse-type load of the system adhering bubbles, in particular, in the valve block, are removed.

In the step then following the accumulator, again, is evacuated and the system restored to the basic state.

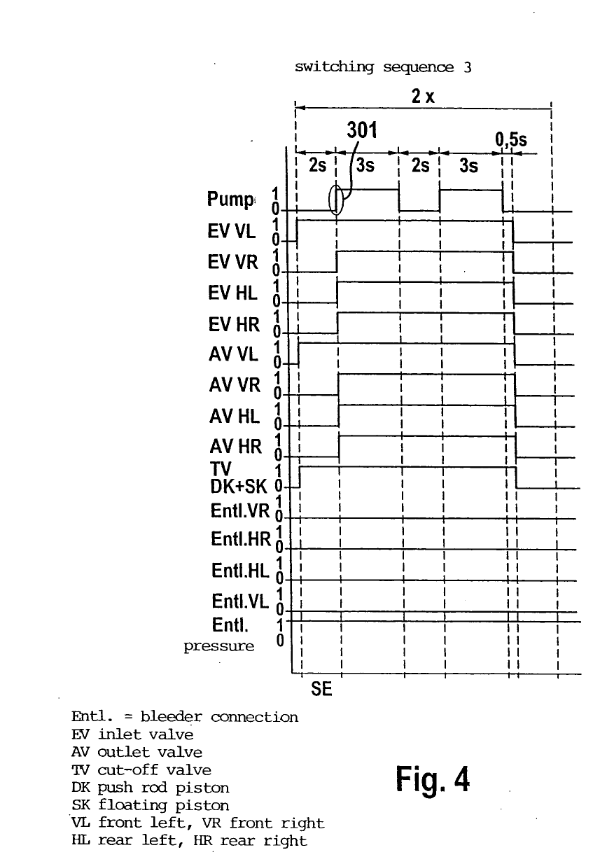

In the following connection sequence 3 (FIG. 4), all inlet valves 8 and all outlet valves 9 are opened. The wheel bleeder connections 20 are closed so that, with the pump 5 activated (marking 301), pressure fluid is delivered from reservoir 4, by means of inlet and outlet valves 8,9 and by means of return conduit 18, back to the pressure fluid reservoir 4. This step, in particular, serves for bleeding return conduit 18. Air enclosed therein will be passed to the pressure fluid reservoir where it will separate from the pressure fluid to collect in the gas phase above the level of filling.

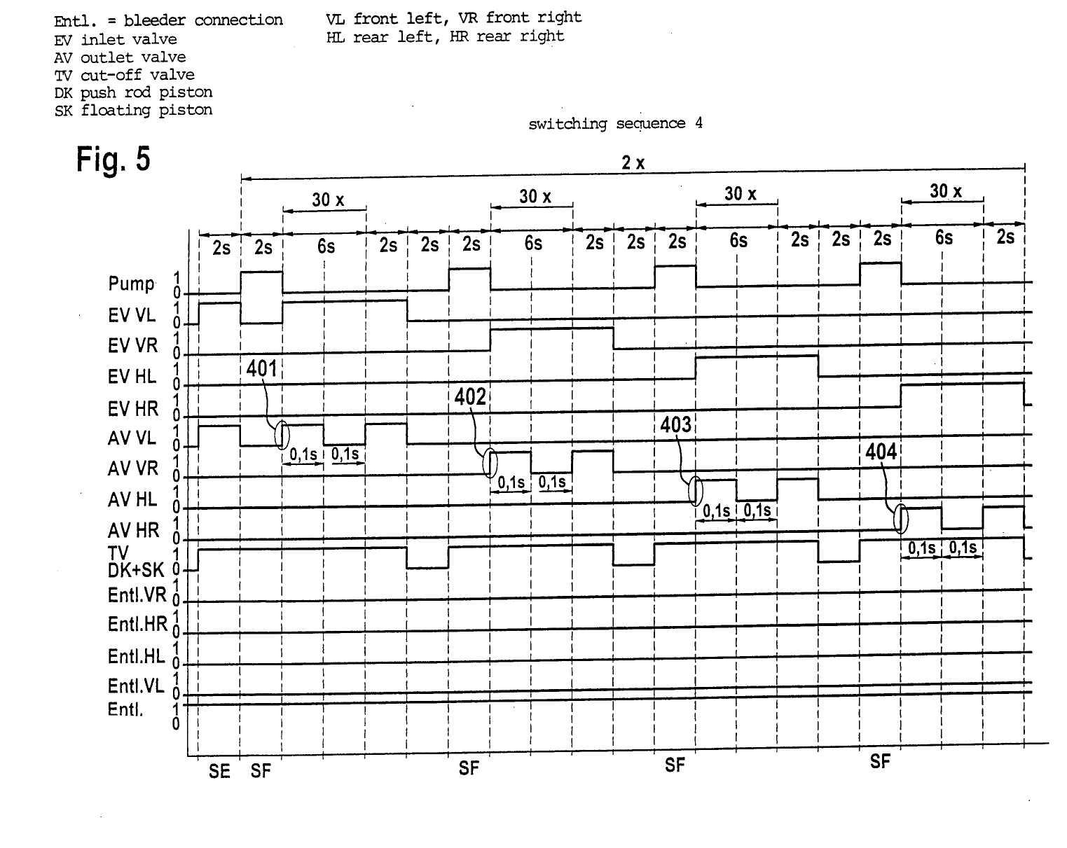

Also, the return conduit 18 is flushed in process step 4 (FIG. 5). However, the outlet valves 9 (markings 401 through 404) are successively circuited in clock-wise manner so that, again, pressure pulses are produced and the return conduit 18 is intermittently flushed to thereby eliminate air bubbles. Connection sequence 4 can be twice performed.

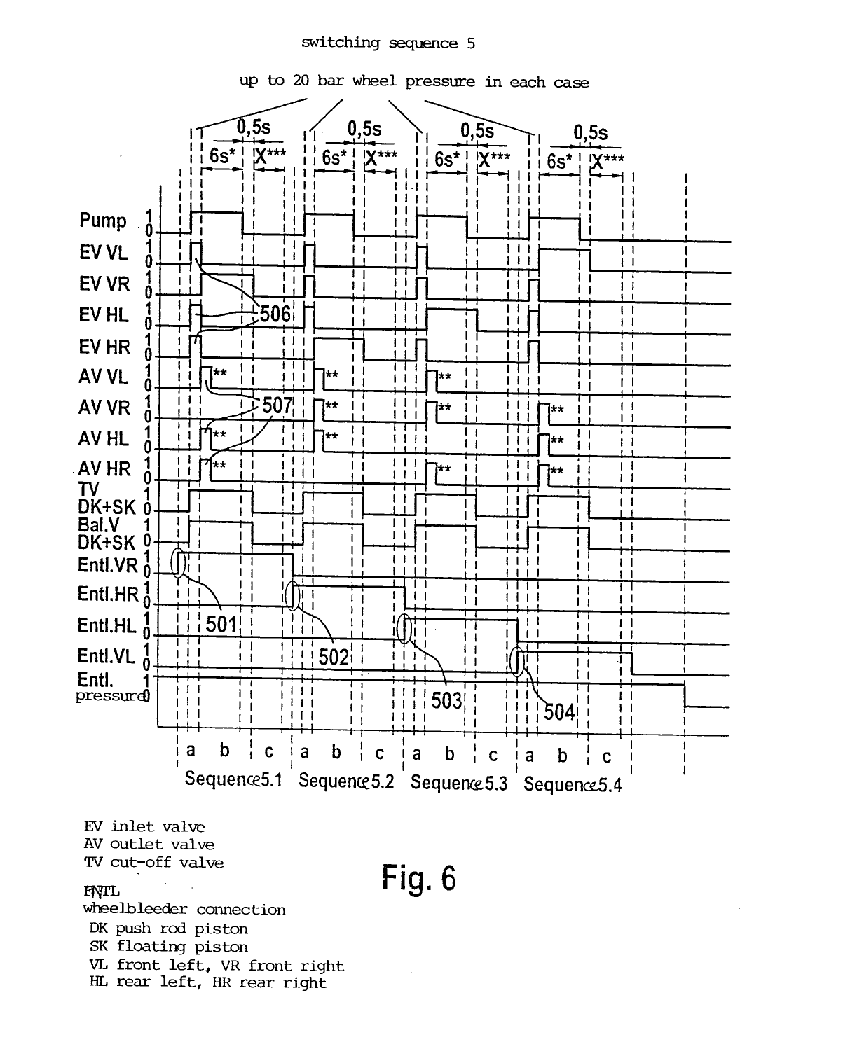

In a final fifth sequence as shown in FIG. 6, the wheel bleeder connections 20 are successively opened (markings 502 through 504) in partial sequences 5.1, 5.2, 5.3 and 5.4, with the other three inlet valves (triples) (marking 506) being opened before the inlet valve 8 of the wheel brake, with the wheel bleeder connection 20 opened (marking 505), so that a pressure builds up in the closed wheel brakes which shortly thereafter is about 2 bar obtained by opening associated outlet valves 9 (marking 507), thereby enabling the pressure in the wheel brakes to be monitored. The said pressure must be in conformity with the given connection states. As a pressure successively builds up and decreases in wheel brakes respectively forming triples, it will be possible to determine whether or not conduits have been transposed.

1-6. (canceled)

7. A method for bleeding and refilling an electrohydraulic brake system, comprising a pedal-operated master brake cylinder and a brake circuit controlled by the master brake cylinder pressure, including a pump the intake side of which, by means of an intake conduit, is in communication with a pressure fluid reservoir, and a high-pressure accumulator as well as inlet and outlet valves for the wheel brakes connected to the brake circuit, with an inlet valve controlling the connection of the related wheel brake to the high-pressure accumulator, and an outlet valve controlling the connection of the related wheel brake to the pressure fluid reservoir by means of a non-pressurized return conduit, and with the master brake cylinder being connected to the brake circuit downstream of the inlet valves by means of a cut-off valve, comprising at least the following steps:
1. Connecting a bleeder bottle to the wheel bleeder connections provided on the wheel brakes.
2. Connecting a bleeder device to a filling nozzle of a pressure fluid reservoir.
3. Activating the pump and delivering pressure fluid out of the reservoir.
4. Connecting the inlet and outlet valves and the cut-off valves such that pressure fluid from the high-pressure accumulator either is fed to the wheel bleeder connections or to the pressure fluid reservoir.

8. A method according to claim 7, wherein a conventional bleeding is performed prior to activating the pump.

9. A method according to claim 7, wherein in case of a bleeding in the pressure fluid reservoir, the pump is actuated in clockwise manner.

10. A method according to claim 7, wherein in case of bleeding the pressure fluid reservoir, the outlet valves are actuated in clockwise manner.

11. A method according to claim 7, wherein the bleeding is effected by a pump in the following order:
Conventional bleeding in the direction of the wheel bleeder connections;
Pump bleeding also in the direction of the wheel bleeder connections;
Loading and bleeding the accumulator in the direction of the wheel bleeder connections;
Loading of the accumulator and bleeding in the direction of the wheel bleeder connections.
Bleeding the pump in the direction of the wheel bleeder connections.

12. A method according to claim 7, wherein during bleeding of the brake system by means of the wheel bleeder connection of one wheel, pressure is applied to the other three wheel brakes by opening the related inlet valves, with the wheel brake pressures being measured and the determined pressure triples being correlated to the connected inlet valves.
